(19) United States
(12) Patent Application Publication
(10) Pub. No.: US 2024/0419773 A1
(43) Pub. Date: Dec. 19, 2024

(54) CODE MODULE USE IN ENDPOINT DEVICES

(71) Applicant: Dell Products L.P., Round Rock, TX (US)

(72) Inventors: ERIC JOSEPH BRUNO, Shirley, NY (US); JOSEPH CAISSE, Burlington, MA (US); BRADLEY K. GOODMAN, Nashua, NH (US)

(21) Appl. No.: 18/336,232

(22) Filed: Jun. 16, 2023

(51) Int. Cl. G06F 21/44; G06F 21/62

(52) U.S. Cl. CPC G06F 21/44; G06F 21/629

(57) ABSTRACT

Methods and systems for securing extended functionality of endpoint devices are disclosed. To extend the functionality of endpoint devices, pre-provisioned code modules may be stored in management systems. To invocate the extended functionality of the endpoint devices, the endpoint devices may request copies of the pre-provisioned code modules from the management systems. Access to the pre-provisioned code modules may be secured using multiple layers of security. If the requirements of the multiple layers of security are fulfilled, access to the pre-provisioned code modules may be provided to extend the functionality of the endpoint devices.

### FIELD

Embodiments disclosed herein relate generally to security. More particularly, embodiments disclosed herein relate to securing extended functionality of devices.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a data flow diagrams in accordance with an embodiment.

FIG. 2B shows an interaction flow diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for extending the functionality of endpoint devices while mitigating risk in extended functionality. To extend the functionality of endpoint devices, code modules executable by the endpoint devices may be provisioned with a management system. The management service may provide copies of the code modules to the endpoint devices as functionality needs arise.

To mitigate risk in extending the functionality of the endpoint devices, the code modules may only be selectively provided to endpoint devices. When a code module is provisioned with the management system, limits on use of the code modules may be put in place based on requested future uses for the code modules.

When a request to extend the functionality of an endpoint device is obtained, the management system may only provide access to code modules that have been pre-provisioned for use by requesting endpoint devices. The management system may selectively provide access to the code modules based on the limitations on the use of the code modules and information provided by the endpoint devices. Thus, endpoint devices may only be provided with access to certain code modules.

To further enhance the security of the endpoint devices, the endpoint devices may verify that the code modules are attested by trusted entities and the integrity of the code modules. The endpoint device may do so using cryptographic signatures from the code modules provided to the endpoint devices.

Additionally, to initiate use of the code modules, the same or different user from those that pre-provisioned the code modules may be required to instruct the endpoint devices to extend their functionality. However, before doing so the endpoint devices may verify the authority of the user with respect to the extended functionality. Consequently, authority for initiating performance of extended functionality may be verified multiple times and through similar or different identity and authority management systems. Accordingly, multiple identity and authority management systems may need to be compromised for the endpoint devices to be maliciously enticed into extending their functionalities in an unauthorized manner.

Thus, embodiments disclosed herein may address, among other technical problems, the technical problem of security in distributed systems. By requiring pre-provisioned code modules to be in place ahead of invocation of extended functionalities of endpoint devices, the likelihood of unauthorized successful invocation of extended functionalities of endpoint devices may be reduced.

In an embodiment, a method for managing operation of an endpoint device is provided. The method may include obtaining, by the endpoint device, a first request for the endpoint device to perform an operation, the operation being performable using code modules managed by a management system; obtaining, by the endpoint device, a second request for a code module of the code modules corresponding to the operation; providing, by the endpoint device, the second request to the management system; obtaining, by the endpoint device and from the management system, a response to the second request; in a first instance of the obtaining where the response comprises the code module; performing at least one validation operation to identify whether the code module is trustworthy; and in a first instance of the performing of the at least one validation operation where the code module is identified as being trustworthy: executing the code module.

The endpoint device may be unable to perform the operation without use of the code module. For example, the endpoint device may lack native functionality to perform the operation with the existing hardware and software components of the endpoint device. The endpoint device functionality may be extended through installation of software, but doing so may be undesirable due to computational resources cost, communication bandwidth, and/or potential introduction of avenues for compromise of the endpoint device.

The at least one validation operation may include at least one of: verifying that that code module is attested by a trusted entity; and verifying integrity of the code module.

The second request may include an identifier for the operation; an identifier of a requestor that made the first request; an identifier for the trusted entity; an identifier for the endpoint device; and a temporal limitation on servicing of the second request.

In the first instance, the code module may include a signature usable to verify that the code module is attested by the trusted entity and to verify the integrity of the code module.

The method may also include, prior to obtaining the first request: identifying a first portion of the code modules that are authorized for use by the endpoint device and a second portion of the code modules that are not authorized for use by the endpoint device; and limiting operations that may be invoked by a requestor based the first portion of the code modules and the second portion of the code modules.

Execution of the code module may allow the endpoint device to perform the operation without installation of any applications.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

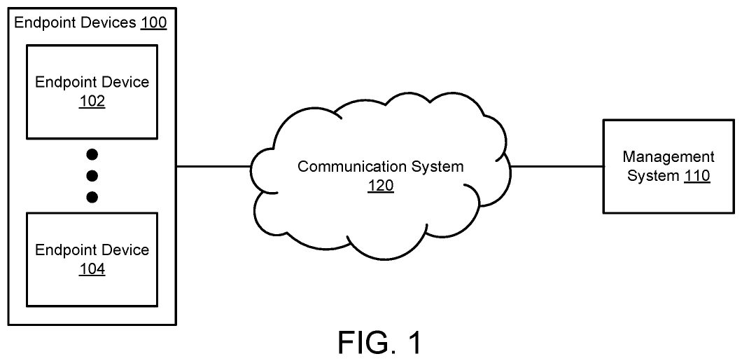

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, the system include endpoint devices 100. Each endpoint device (e.g., 102, 104) may provide similar and/or different computer implemented services, and may provide the computer implemented services independently and/or in cooperation with other endpoint devices.

To provide the services, each of endpoint devices 100 may host computer code that when executed causes the endpoint devices to provide corresponding computer services. The type and selection of computer implemented services that an endpoint device may provide may be limited by the computer code available for execution.

To expand the type and/or quantity of computer implemented services provided by endpoint devices 100, additional computer code may be deployed to endpoint devices 100. To do so, an administrator or other person may identify themselves to endpoint devices 100 and initiate installation of computer code.

However, allowing software to be installed on endpoint devices 100 may present security risks. For example, if a malicious actor is able to impersonate an authorized user, the malicious actor may be able to install undesired computer code on endpoint devices 100.

Further, when endpoint devices 100 are used in edge deployments or other systems that may have limited available infrastructure (e.g., limited rack space, internet connectivity, head units such as human interface devices and displays, other facilities, etc.), installing additional computer code may present challenges that may prevent timely installation. For example, limited internet connectivity or available personnel may prevent computer code from being installed on endpoint devices within desired periods of time. Consequently, endpoint devices 100 may be unable to provide desired computer implemented services. In general, embodiments disclosed herein may provide methods, systems, and/or

devices for dynamically modifying the functionality of endpoint devices in a manner that manages security risks presented by changes in functionality of endpoint devices. To manage security risks presented by changes in functionality of endpoint devices, the system may implement a three-part security model where (i) endpoint devices verify that requestors of new functionalities are trusted, (ii) endpoint devices limit their extensibility to those that may be implemented using code modules that are pre-provisioned with and verified as trustworthy by other systems, and (iii) endpoint devices, prior to use of code modules, verify that obtained code modules are attested by trusted entities and verify the integrity of the obtained code modules.

To dynamically modify the functionality of endpoint devices, the verifiable and executable code modules may be pre-provisioned with management entities trusted by the endpoint devices. Execution of a code module by an endpoint device may enable the endpoint device to provide additional computer implemented services that may not otherwise be provided.

To execute a code module, an endpoint device may (e.g., at the request of a user) make a request to the management entity for access to a corresponding code module. The management entity may provide access to the corresponding code module if the request for the code module meets limits for use of the code module (e.g., such as which endpoint devices may use the code module, which entities may request use of the code modules for the endpoint devices, etc.). The limits on use of code modules may be established through separate systems maintained by the management system.

By doing so, functionality of endpoint devices may be dynamically extended while limiting risk presented by extensible functionality and managing challenges presented by various computing environments.

To provide the above noted functionality, the system of FIG. 1 may include endpoint devices 100 and management system 110. Each of these components is discussed below.

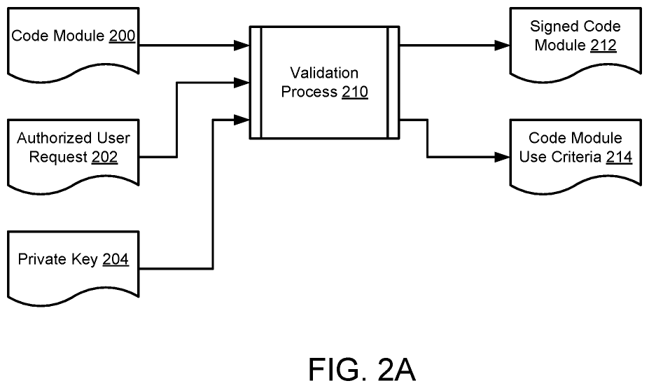

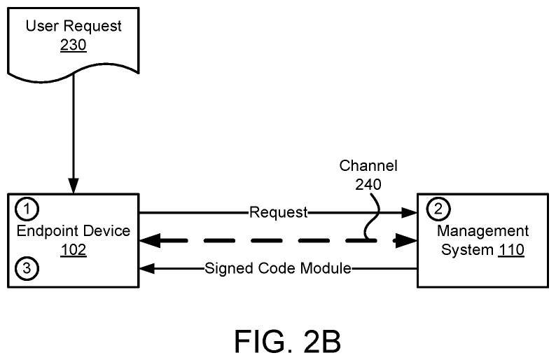

Endpoint devices 100 may provide computer implemented services that may be extended through use of code modules. To extend its functionality, an endpoint device may (i) obtain a request for performance of an operation that it is unable to natively perform, (ii) verify that the requestor is trusted and authorized with respect to invocation of the operation, (ii) once verified, generate and send a request for a corresponding code module to management system, (iii) after receiving the code module, verify the code module, and (iv) once verified, execute the code module to perform the requested operation. Refer to FIGS. 2A-2B for additional details regarding the operation of endpoint devices 100.

Management system 110 may manage code modules for use by endpoint devices. To do so, management system 110 may (i) obtain code modules for pre-provisioning for future requests from endpoint devices, (ii) obtain limits on the use of the code modules, (iii) sign the code modules, and (iv) service requests for the code modules that can be validated by securely providing access to the corresponding signed code modules.

The code modules may be pre-provisioned, for example, by entities that have sufficient privileges to invoke operations to be performed by the endpoint devices. When another entity wishes to invoke these operations, an endpoint device may request a corresponding code module.

To manage access and use of the code modules, management system 110 may cooperate with endpoint devices. For example, management system 110 may provide endpoint devices with information regarding pre-provisioned code modules that are authorized for use with the requesting endpoint devices. The endpoint devices may use this information to present user of the endpoint system with information regarding available operations that may be performed using the pre-provisioned code modules, and through which the native functionality of the endpoint devices may be extended. Refer to FIGS. 2A-2B for additional details regarding the operation of management system 110.

Endpoint devices 100 and management system 110 may implement identity and access management systems (e.g., password protected user accounts, linked to corresponding privileges) through which users of the systems may be verified, and privileged use of functionalities of the respective devices/systems may be ascertained. Thus, to pre-provision a code modules for subsequent use with an endpoint system, a user may first be verified with management system 110. During subsequent operation of an endpoint system, another (or the same) user that attempts to invoke use of pre-provision code modules may first be verified with respect to the endpoint device. Thus, to invoke functionality of an endpoint device supplement with a code module, multiple identity and access management systems may need to be cleared.

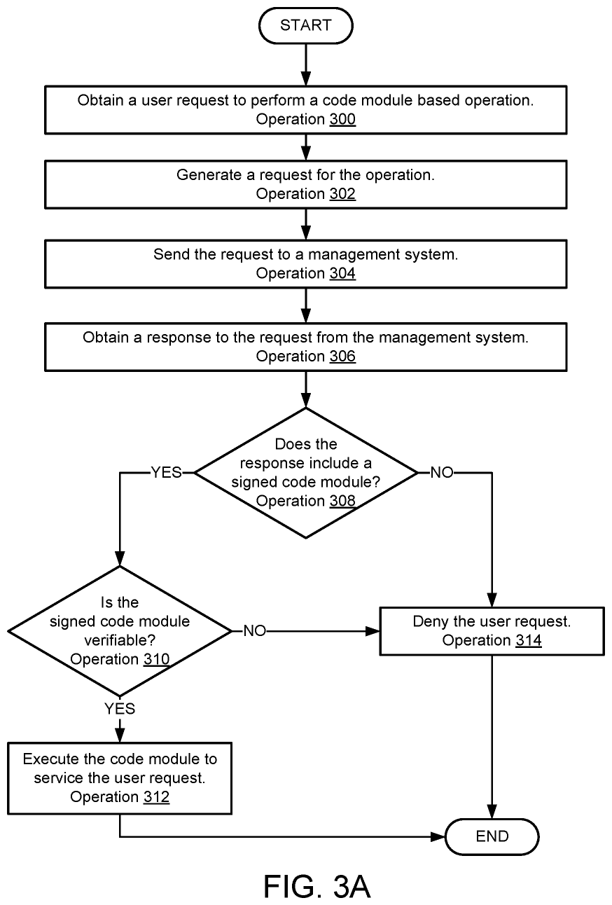

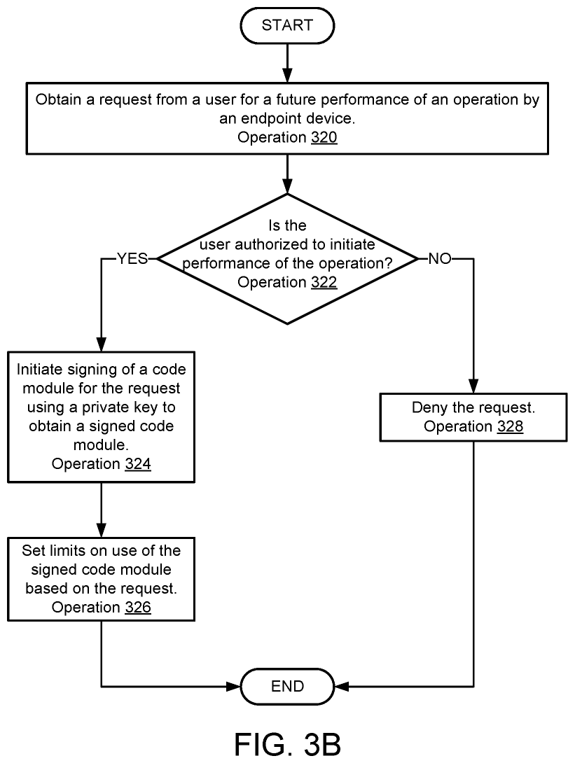

When providing their functionality, any of (and/or components thereof) endpoint devices 100 and/or management system 110 may perform all, or a portion, of the methods illustrated in FIGS. 3A-3B.

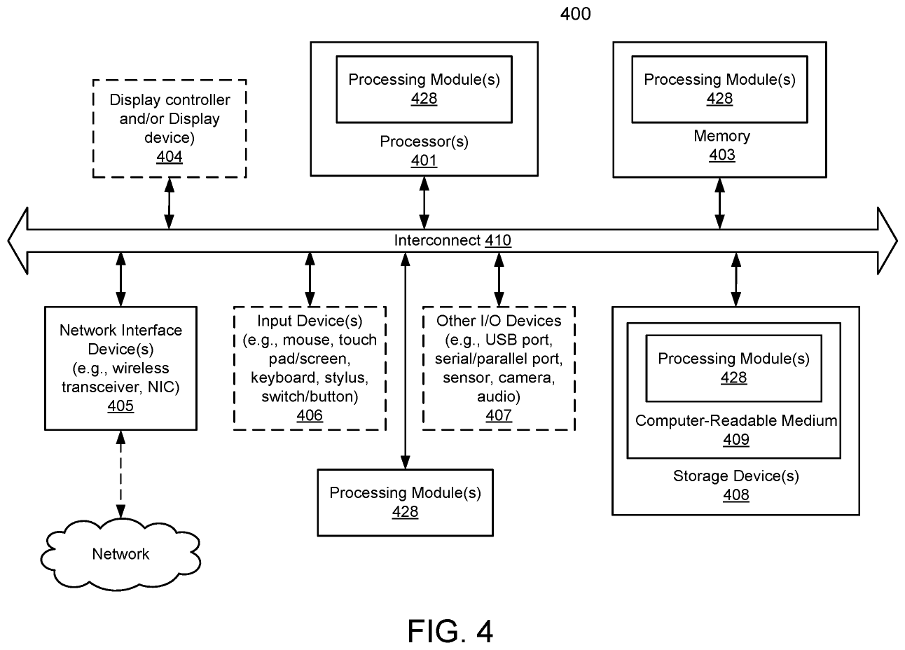

Any of (and/or components thereof) endpoint devices 100 and management system 110 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 120. In an embodiment, communication system 120 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those components illustrated therein.

As discussed above, the system of FIG. 1 may facilitate extended functionalities of endpoint devices through use of pre-provisioned code modules.

Turning to FIG. 2A, a data flow diagram in accordance with an embodiment is shown. Pre-provisioned code modules may be established using the first data flow shown in FIG. 2A. In FIG. 2A, a first set of shapes (e.g., 200, 202, 204, 212, 214) is used to illustrate data structures and a second set of shapes (e.g., 210) is used to illustrate processes that may use the data structures and/or generate the data structures.

To pre-provision a code module for future use with endpoint devices, management system may verify that the user is trusted by a management system (e.g., by requiring that the user supply a username and password or other type of credentials). Once verified, the user may initiate validation process 210 for a code module. Validation process 210 may be performed to pre-provision an integrity verifiable and attested code module for use by certain endpoint devices.

To do so, during validation process 210 code module 200, authorized user request 202, and private key 204 may be obtained and used. These data structures may include information usable to establish and limit access to code modules. Each of these data structures is discussed below.

Code module 200 may include any amount of computer code that when executed by an endpoint device causes the endpoint device to perform one or more operations. Thus, providing a copy of code module 200 to an endpoint device may enable the endpoint device to extend its functionality using the code module 200.

Authorized user request 202 may be a request, by an authorized user (as previously verified), to pre-provision code module 200 for use by endpoint devices. Authorized user request 202 may specify various criteria usable by a management system to identify under what conditions code module 200 may be used by endpoint devices. For example, authorized user request 202 may specify limitations regarding (i) which endpoint devices may use particular code modules, (ii) when code modules may be used, (iii) types of proof or other information that must be provided for a code module to be used, etc. and/or requests for completion of certain operations on endpoint devices (e.g., perform an operation on a particular endpoint device, group of devices, etc.).

Private key 204 may be, for example, a cryptographic key (e.g., part of a public-private key pair). The cryptographic key may be associated with an entity that is trusted by the endpoint device. For example, the cryptographic key may be an estate key (e.g., for a domain, a control plane, etc.) or other type of key which endpoint devices have been configured to trust.

For authorized users, validation process 210 may orchestrate signing of code module 200 using private key 204 to obtain signed code module 212. Thus, signed code module 212 may be attested by virtue of the signature by the trusted entity associated with private key 204, and be verifiable as having not been modified during transit from a management system to an endpoint device (e.g., the algorithm to generate the signature may use code module 200 and private key 204 as ingests thereby allowing for the integrity of the code module to be verified).

To manage use of signed code module 212, code module use criteria 214 may also be generated. The content of code module use criteria 214 may be based on authorized user request 202. For example, code module use criteria 214 may specify under what conditions signed code module 212 may be used. These conditions may reflect which endpoint devices may use corresponding signed code modules.

Thus, using the data flow shown in FIG. 2A, code modules may be pre-provisioned for subsequent use by endpoint devices.

Turning to FIG. 2B, an interaction diagram in accordance with an embodiment is shown. An endpoint device 102 may use a pre-provisioned code modules through the interactions shown in FIG. 2B. In FIG. 2B, a first set of shapes (e.g., 230) is used to illustrate data structures and a second set of shapes (e.g., 102, 110) is used to illustrate components that may use the data structures. Additionally, in FIG. 2B, a third set of numbered shapes (e.g., 1, 2, 3) is used to indicate activity by the components of the system. The number of the third set of shapes may indicate an example temporal ordering between the activities. However, it will be appreciated that the activities may be performed in other orders, and/or there may be additional, different, and/or fewer activities performed than shown herein without departing from embodiments disclosed herein.

To use pre-provisioned code modules, a user may initiate, at block 1, performance of an operation by endpoint device 102. To initiate performance of the operation, the user may provide endpoint device 102 with user request 230. User request 230 may indicate the operation to be performed by endpoint device 102. User request 230 may be generated by endpoint device 102 (e.g., by receiving user input from the user), may be read from storage, or may be received from another device.

To prevent unauthorized entities from invoking functionalities of endpoint device 102, endpoint device 102 may require that the user authenticate themselves to endpoint device 102. The authentication may be performed using any mechanism (e.g., such as by requiring the user to provide a name and password, and/or other types of credentials). Once authenticated, endpoint device 102 may obtain and/or process user request 230.

To manage the types of functionalities that the user may invoke, endpoint device 102 may limit those functionalities to (i) natively performable functionalities which the user is authorized to invoke (e.g., as specified by a permissions management system) and (ii) extensible functionalities which endpoint device 102 may perform using pre-provisioned code modules from management system 110.

To identify the extensible functionalities, endpoint device 102 may establish channel 240. Channel 240 may be a secure (e.g., encrypted) communication channel between endpoint device 012 and management system 110. Using channel 240, endpoint device 102 may query management system 110 regarding the pre-provisioned code modules. Management system 110 may respond to the query and provide information regarding the pre-provisioned code modules that are usable by endpoint device 102. Endpoint device 102 may use the obtained information to inform the user of the operations that may be provided by endpoint device 102. In this manner, endpoint device 102 may limit the operations that the user may attempt to invoke.

After the user has invoked performance of an operation using a pre-provisioned code module by providing user request 230, endpoint device 102 may generate and send a request for a corresponding code module to management system 110 via channel 240. The request may include (i) an identifier of the operation (or and identifier of the pre-provisioned code module) that will be performed by endpoint device 102, (ii) an identifier for the user the has invoked performance of the operation, (iii) an identifier of endpoint device 102, (iv) a timestamp indicating when performance of the operation is invoked by a user, (v) timeliness information regarding how quickly the operation must be performed (e.g., may specify when the request will expire), (vi) other identifiers such as an identifier of an estate, a control plane, and/or other type of collection of data processing systems, and/or other information usable by management system 110 to ascertain how to respond to the request.

When obtained, at block 2, management system 110 may process the request by using the identifiers to ascertain whether endpoint device 102 should be provided with a pre-provisioned code module corresponding to the type of operation to be performed by endpoint device 102. Management system 110 may make the determination, for example, by comparing the content of the request code module use criteria (e.g., 214) for the pre-provisioned code module corresponding to the requested operation. If the code module use criteria are met, then a copy of the signed code module may be provided to endpoint device 102.

When the signed code module is obtained by endpoint device 102, at block 3, endpoint device 102 may verify that the code module is attested and has not been modified. To do so, endpoint device 102 may perform a signature verification process for the signed code module. If the signature of the signed code module is verified (e.g., using a public key of a trusted entity), then the code mode may be treated as being both attested and having not been tampered with by any entities. The verified code module may be executed by endpoint device 102 thereby causing endpoint device 102 to provide the desired functionality invoked by the user.

The interactions shown in FIG. 2B may enhance the security of endpoint devices through use of multiple security mechanisms while providing for extensible functionality of the endpoint devices. By requiring that a pre-provisioned code module be present prior to servicing of endpoint device side requests, multiple check of credentials may be performed: (i) a first during the provisioning and (ii) a second during invocation of an operation on the endpoint device.

Additionally, by pre-provisioning code modules, users with different levels of system wide permissions may cooperatively manage the operation of endpoint devices. For example, in a tiered permissions system where administrators have different levels of permissions, the ability to pre-provision code modules with management system 110 may be limited to a fewer number of persons. In contrast, the ability to invoke execution of the pre-provisioned code modules may be a more widely held permission. Consequently, administrators with higher levels of permissions may granularly manage the ability of administrators with lower levels of permissions to invoke performance of the functions of different endpoint devices 102.

As discussed above, the components of FIG. 1 may perform various methods to manage the operation of endpoint devices. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method for managing secure operation of endpoint devices in accordance with an embodiment is shown. The method may be performed by any of endpoint devices 100, management system 110, and/or other components of the system shown in FIG. 1.

Prior to operation 300, one or more pre-provisioned code modules may be obtained by a management system tasked with managing endpoint devices. The code modules may be pre-provisioned using the method illustrated in FIG. 3B.

At operation 300, a user request to perform a code module based operation is obtained. The user request may be obtained by (i) verifying that the user is authorized to invoke functionality of an endpoint device, (ii) if successfully verified, identifying the code modules available from a management system that are available for user by the endpoint device, (iii) providing the user with information regarding the operations of the endpoint device that may be performed using the code modules, and (iv) obtaining the user request by receiving user input and generating the user request, receiving the use request from another device, and/or via another method. The user may use the endpoint device directly (e.g., using a human interface device such as mouse and keyboard) or indirectly (e.g., via a management console or other remote management tool).

At operation 302, a request for the operation may be generated. The request may be generated by populating a data structure with information regarding (i) the operation to be performed, (ii) the user that requested performance of the operation, (iii) the endpoint device, (iv) temporal information such as time stamps regarding when the request is initiated by a user, when the request needs to be completed, etc., (v) information regarding a manager of the endpoint device (e.g., such as an estate to which the endpoint device belongs), and/or other types of information which a management system may use to evaluate the request.

At operation 304, the request is provided to a management system. The request may be provided by, for example, sending the request to the management system via a secure channel between the endpoint device and the management system.

At operation 306, a response from the management system is obtained. The response may be obtained by receiving the response from the management system via the channel over which the request is provided, or via a different communication channel.

At operation 308, a determination is made regarding whether the response includes a signed code module. The response may include the signed code module based on the management system's evaluation of the request. If the response includes the signed code module, then the method may proceed to operation 310. Otherwise the method may proceed to operation 314.

At operation 310, a determination is made regarding whether the signed code module is verifiable. The determination may be made by (i) ascertaining whether the code module is attested by a trusted entity and (ii) ascertaining whether the integrity of the code module can be verified. To do so, a signature verification process may be performed. If the signature can be verified with a public key of a trusted entity, then the code module may be treated as being attested and as having passed the integrity verification. The signature verification process may be performed using a signature verification algorithm that uses the public key to ascertain whether the signature was generated using a corresponding private key and the code module as an ingest.

If the signed code module is verifiable, then the method may proceed to operation 312. Otherwise, the method may proceed to operation 314.

At operation 312, the code module is executed to service the user request. Executing the code module may cause the endpoint device to perform a functionality that may not be natively performed by the endpoint device based on the available hardware and installed software. Thus, the functionality of an endpoint device may be extended without requiring installation of additional software and/or downloading of frameworks to support the additional software.

The method may end following operation 312.

Returning to operation 308, the method may proceed to operation 314 following operation 308 if the response does not include the signed code module and following operation 310 if the signed code module is included in the response but is not verifiable.

At operation 314, the user request is denied. The user request may be denied by not performing the operation indicated by the user request of operation 300.

The method may end following operation 314.

Using the method illustrated in FIG. 3A, the functionality of an endpoint device may be dynamically extended without needing to install additional software, while mitigating risk in extension functionality of the endpoint device.

Turning to FIG. 3B, a flow diagram illustrating a method for pre-provisioning a code module in accordance with an embodiment is shown. The method may be performed by any of endpoint devices 100, management system 110, and/or other components of the system shown in FIG. 1.

At operation 320, a request for a future performance of an operation by at least one endpoint device is obtained. The request may be obtained from a user. The request may include a code module usable to perform the operation, and one or more limitations on use of the code module (e.g., use criteria).

At operation 322, a determination is made regarding whether the user is authorized to initiate performance of the operation by the at least one endpoint device in the future. The determination may be made by submitting credentials for the user to an identification and access management system (e.g., which tracks authorizations for different entities) used by a management system. The credentials may be provided by the user. The identification and access management system may indicate whether the user is authorized to initiate performance of the operation.

The identification and access management system used by the management system of FIG. 1 may be similar or different from an identification and access management system used by endpoint devices.

If the user is authorized to initiate the future performance of the operation, the method may proceed to operation 324. Otherwise, the method may proceed to operation 328.

At operation 324, signing of the code module for the request may be initiated. The code module may be signed using a private key (e.g., of a trusted entity, the key may be an estate key). The public key corresponding to the private key may be accessible by endpoint devices via a key manager (not shown) that may advertise and/or otherwise manage keys used by the system of FIG. 1.

At operation 326, limits on use of the signed code module are set based on the request. The limits may include, for example, limits on the endpoint devices that may utilize the signed code module, limits on when the signed code module may be used, etc. Any number and types of limits may be set based on the request from the user, and/or authority of the user (e.g., if the user is not authorized to initiate performance of operations by certain endpoint devices, then the signed code module may be limited from use by the certain endpoint devices).

The method may end following operation 326.

Returning to operation 322, the method may proceed to operation 328 following operation 322 when the user is not authorized to initiate performance of the operation.

At operation 328, the request is denied. Denial of the request may prevent the code module from being signed which may in turn prevent use of the code module by endpoint devices.

The method may end following operation 328.

Thus, using the method illustrated in FIG. 3B, code modules may be pre-provisioned for future used, and corresponding limitations on the use of the code module may be established. Consequently, for a code module to be used by an endpoint device, a signed code module may need to be pre-provisioned at a management system and a user may need to authenticate to an endpoint system. Thus, the likelihood of unauthorized use of code modules may be reduced.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein.

Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both.

Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of an endpoint device, the method comprising:
obtaining, by the endpoint device, a first request for the endpoint device to perform an operation, the operation being performable using code modules managed by a management system;
obtaining, by the endpoint device, a second request for a code module of the code modules corresponding to the operation;
providing, by the endpoint device, the second request to the management system;
obtaining, by the endpoint device and from the management system, a response to the second request;
in a first instance of the obtaining where the response comprises the code module;
performing at least one validation operation to identify whether the code module is trustworthy; and
in a first instance of the performing of the at least one validation operation where the code module is identified as being trustworthy:
executing the code module.

2. The method of claim 1, wherein the endpoint device is unable to perform the operation without use of the code module.

3. The method of claim 2, wherein the at least one validation operation comprises at least one of:
verifying that that code module is attested by a trusted entity; and
verifying integrity of the code module.

4. The method of claim 3, wherein the second request comprises:
an identifier for the operation;
an identifier of a requestor that made the first request;
an identifier for the trusted entity;
an identifier for the endpoint device; and
a temporal limitation on servicing of the second request.

5. The method of claim 3, wherein in the first instance, the code module comprises a signature usable to verify that the code module is attested by the trusted entity and to verify the integrity of the code module.

6. The method of claim 1, further comprising:
prior to obtaining the first request:
identifying a first portion of the code modules that are authorized for use by the endpoint device and a second portion of the code modules that are not authorized for use by the endpoint device; and
limiting operations that may be invoked by a requestor based the first portion of the code modules and the second portion of the code modules.

7. The method of claim 1, wherein execution of the code module allows the endpoint device to perform the operation without installation of any applications.

8. A non-transitory machine-readable medium having instructions stored therein, which when executed by at least one processor, cause a system to perform system first operations for managing operation of an endpoint device, the system first operations comprising:
obtaining, by the endpoint device, a first request for the endpoint device to perform an operation, the operation being performable using code modules managed by a management system;
obtaining, by the endpoint device, a second request for a code module of the code modules corresponding to the operation;
providing, by the endpoint device, the second request to the management system;
obtaining, by the endpoint device and from the management system, a response to the second request;
in a first instance of the obtaining where the response comprises the code module;
performing at least one validation operation to identify whether the code module is trustworthy; and
in a first instance of the performing of the at least one validation operation where the code module is identified as being trustworthy:
executing the code module.

9. The non-transitory machine-readable medium of claim 8, wherein the endpoint device is unable to perform the operation without use of the code module.

10. The non-transitory machine-readable medium of claim 9, wherein the at least one validation operation comprises at least one of:
verifying that that code module is attested by a trusted entity; and
verifying integrity of the code module.

11. The non-transitory machine-readable medium of claim 10, wherein the second request comprises:
an identifier for the operation;
an identifier of a requestor that made the first request;
an identifier for the trusted entity;
an identifier for the endpoint device; and
a temporal limitation on servicing of the second request.

12. The non-transitory machine-readable medium of claim 10, wherein in the first instance, the code module comprises a signature usable to verify that the code module is attested by the trusted entity and to verify the integrity of the code module.

13. The non-transitory machine-readable medium of claim 8, wherein the first operations further comprise:
prior to obtaining the first request:
identifying a first portion of the code modules that are authorized for use by the endpoint device and a second portion of the code modules that are not authorized for use by the endpoint device; and
limiting second operations that may be invoked by a requestor based the first portion of the code modules and the second portion of the code modules.

14. The non-transitory machine-readable medium of claim 8, wherein execution of the code module allows the endpoint device to perform the operation without installation of any applications.

15. An endpoint device, comprising:
at least one processor; and
a memory coupled to the processor to store instructions, which when executed by the processor, cause the endpoint device to perform first operations for managing operation of the endpoint device, the first operations comprising:
obtaining, by the endpoint device, a first request for the endpoint device to perform an operation, the operation being performable using code modules managed by a management system;
obtaining, by the endpoint device, a second request for a code module of the code modules corresponding to the operation;
providing, by the endpoint device, the second request to the management system;
obtaining, by the endpoint device and from the management system, a response to the second request;
in a first instance of the obtaining where the response comprises the code module;
performing at least one validation operation to identify whether the code module is trustworthy; and
in a first instance of the performing of the at least one validation operation where the code module is identified as being trustworthy:
executing the code module.

16. The endpoint device of claim 15, wherein the endpoint device is unable to perform the operation without use of the code module.

17. The endpoint device of claim 16, wherein the at least one validation operation comprises at least one of:
verifying that that code module is attested by a trusted entity; and
verifying integrity of the code module.

18. The endpoint device of claim 17, wherein the second request comprises:
an identifier for the operation;
an identifier of a requestor that made the first request;
an identifier for the trusted entity;
an identifier for the endpoint device; and
a temporal limitation on servicing of the second request.

19. The endpoint device of claim 17, wherein in the first instance, the code module comprises a signature usable to verify that the code module is attested by the trusted entity and to verify the integrity of the code module.

20. The endpoint device of claim 15, wherein the first operations further comprise:
prior to obtaining the first request:
identifying a first portion of the code modules that are authorized for use by the endpoint device and a second portion of the code modules that are not authorized for use by the endpoint device; and
limiting second operations that may be invoked by a requestor based the first portion of the code modules and the second portion of the code modules.
